(19) United States
(12) Patent Application Publication
(10) Pub. No.: US 2009/0103057 A1
(43) Pub. Date: Apr. 23, 2009

(54) AUTOMATIC IRIS DIAPHRAGM MODULE

(75) Inventors: Chih-Hao Wu, Hsinchu (TW); Kuan-Chou Ko, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/111,978

(22) Filed: Apr. 30, 2008

(30) Foreign Application Priority Data
Oct. 23, 2007 (TW) 96217744

(51) Int. Cl. G03B 21/14

(52) U.S. Cl. 353/97

(57) ABSTRACT

An automatic iris diaphragm module is adapted to a projector having a casing, and is capable of adjusting a size of luminous flux of a light source of the projector. The automatic iris diaphragm module is provided with a chassis, a fixed mask, a movable mask, a drive rack, and a motor. The chassis is fixed on the casing. The fixed mask is fixed on the chassis and has an opening. The movable mask is slidably disposed on the fixed mask. The drive rack is fixed on the movable mask. The motor is fixed on the chassis and has a driving gear engaging with the drive rack for driving the drive rack to make the movable mask slide relative to the fixed mask, for adjusting the size of the luminous flux of the light source through the opening.

### CROSS-REFERENCE TO RELATED APPLICATION

This application claims the priority benefit of Taiwan application serial no. 96217744, filed on Oct. 23, 2007. The entirety the above-mentioned patent application is hereby incorporated by reference herein and made a part of specification.

### BACKGROUND OF THE INVENTION

1. Field of the Invention

The present invention relates to an automatic iris diaphragm module adapted to a projector.

2. Description of Related Art

In recent years, with the development of the projector technology, diaphragms are gradually applied in the projectors. Currently, a normal diaphragm applied in a projector is the automatic iris diaphragm having an opening that can be adjusted according to brightness changes of projected images. When a projected image has a large dark area, the opening of the diaphragm becomes smaller to reduce the projected light, so as to relatively improve the contrast of the projected image, and to improve the quality of the projected image. However, current automatic iris diaphragm modules applied in the projectors use complicated drive mechanisms, which lower the reliability, and increase the cost.

### SUMMARY OF THE INVENTION

The present invention is directed to an automatic iris diaphragm module adapted to a projector and capable of adjusting a size of luminous flux of a light source of the projector.

An automatic iris diaphragm module according to an embodiment of the present invention is adapted to a projector having a casing, and capable of adjusting a size of luminous flux of a light source of the projector. The automatic iris diaphragm module is provided with a chassis, a fixed mask, a movable mask, a drive rack, and a motor. The chassis is fixed on the casing. The fixed mask is fixed on the chassis and has an opening. The movable mask is slidably disposed on the fixed mask. The drive rack is fixed on the movable mask. The motor is fixed on the chassis and has a driving gear engaging with the drive rack for driving the drive rack to make the movable mask slide relative to the fixed mask, for adjusting the size of the luminous flux of the light source through the opening.

In the mentioned embodiments of the present invention, the driving gear of the motor is used to drive the drive rack fixed on the movable mask, such that the movable mask slides relative to the opening of the fixed mask, so as to adjust the size of the luminous flux of the light source through the opening.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of an automatic iris diaphragm module according to an embodiment of the present invention.

FIG. 2 is a schematic view of the automatic iris diaphragm module of FIG. 1 assembled in a casing.

FIG. 3 is an exploded view of the automatic iris diaphragm module of FIG. 1.

FIG. 4 is a three-dimensional view of the automatic iris diaphragm module of FIG. 1 after the opening is adjusted.

### DETAILED DESCRIPTION OF THE PREFERRED EMBODIMENTS

In the following detailed description of the preferred embodiments, reference is made to the accompanying drawings which form a part hereof, and in which is shown by way of illustrating specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

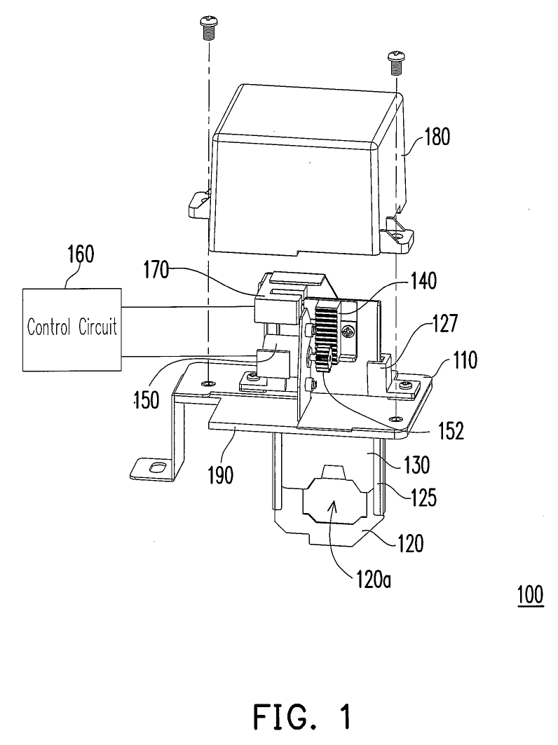

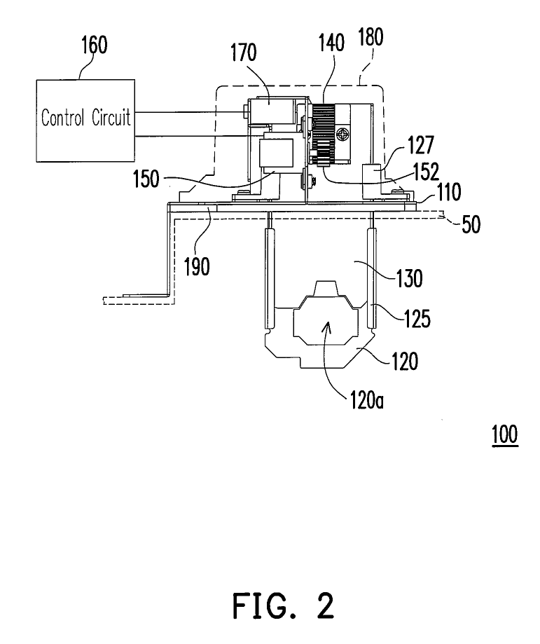

FIG. 1 is a three-dimensional view of an automatic iris diaphragm module according to an embodiment of the present invention. FIG. 2 is a schematic view of the automatic iris diaphragm module of FIG. 1 assembled in a casing. Referring to FIGS. 1 and 2, the automatic iris diaphragm module of this embodiment (referred to as the diaphragm module hereafter) 100 is adapted to a projector having a casing 50, for adjusting a size of luminous flux of a light source (not shown) of the projector.

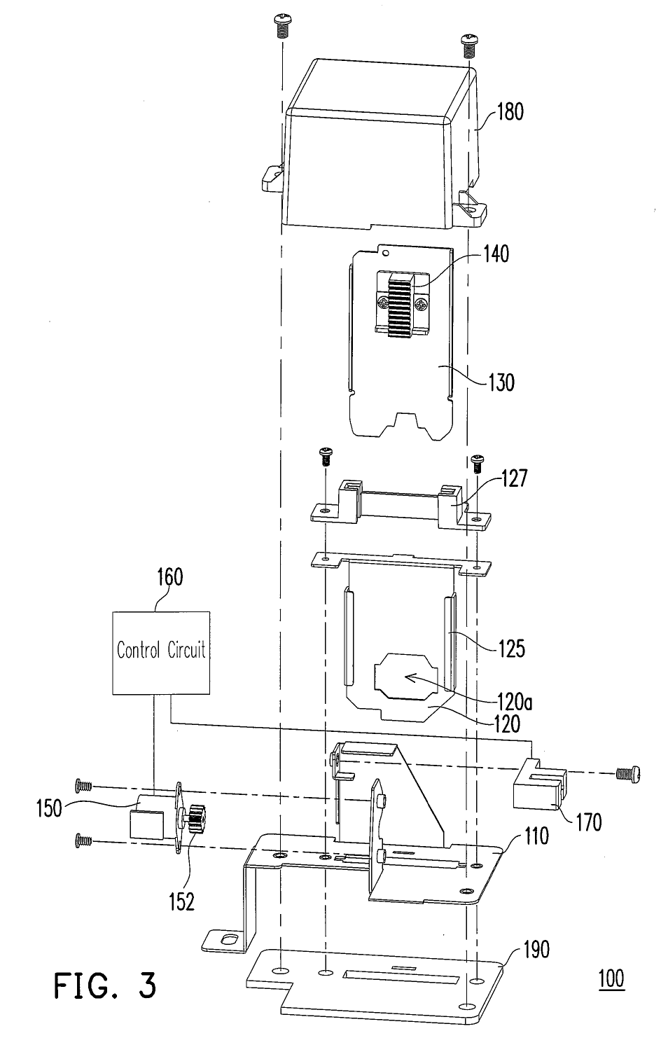

FIG. 3 is an exploded view of the automatic iris diaphragm module of FIG. 1. Referring to FIGS. 1, 2, and 3, the diaphragm module 100 includes a chassis 110, a fixed mask 120, a movable mask 130, a drive rack 140, and a motor 150. The chassis 110 is fixed on a casing 50. The fixed mask 120 is fixed on the chassis 110 and has an opening 120a. In addition, the movable mask 130 is slidably disposed on the fixed mask 120. The drive rack 140 is fixed on the movable mask 130. The motor 150 is fixed on the chassis 110 and has a driving gear 152. The driving gear 152 is engaged with the drive rack 140 for driving the drive rack 140 to make the movable mask 130 slide relative to the fixed mask 120, for adjusting the size of the luminous flux of the light source through the opening 120a. In this embodiment of the present invention, the motor 150 is a stepper motor, which helps to precisely adjust the size of the opening 120a.

In this embodiment of the present invention, the automatic iris diaphragm model 100 further includes a pair of slide rails 125 fixed on the fixed mask 120 and fitting two sides of the movable mask 130 respectively. Therefore, the movable mask 130 fits the pair of slide rails 125 with the two sides thereof, so as to be slidably disposed on the fixed mask 120. Thus, the movable mask 130 may be driven by the motor 150 and slide relative to the opening 120a of the fixed mask 120. In this embodiment of the present invention, the pair of slide rails 125, for example, are U-shaped and disposed at two sides of the fixed mask 120 respectively.

In this embodiment of the present invention, the automatic iris diaphragm module 100 further includes a pair of guide rails 127 fixed on the chassis 110 and located at a side opposite to the pair of slide rails 125. Therefore, the two sides of the movable mask 130 fit the pair of guide rails 127 respectively, so as to ensure the movable mask 130 will not be deflected when sliding relative to the fixed mask 120.

The diaphragm module 100 further includes a control circuit 160 electrically coupled to the motor 150, for controlling the rotation of the motor 150. Therefore, the control circuit 160 can indirectly control the slide of the movable mask 130, so as to adjust the size of the luminous flux of the light source through the opening 120a, as shown in FIG. 3. In this embodiment of the present invention, the control circuit 160 is integrated into a system circuit of the projector, i.e., the control circuit 160 is a part of the system circuit.

Referring to FIGS. 1 and 2 again, the diaphragm module 100 further includes a sensor 170 fixed on the chassis 110 and electrically coupled to the control circuit 160, for sensing the slide of the movable mask 130. Therefore, the control circuit 160 may acquire a sliding distance of the movable mask 130 through the sensor 170, so as to determine whether the luminous flux of the light source through the opening 120a is adjusted to the required size or not. In this embodiment of the present invention, the sensor 170 is a photosensor.

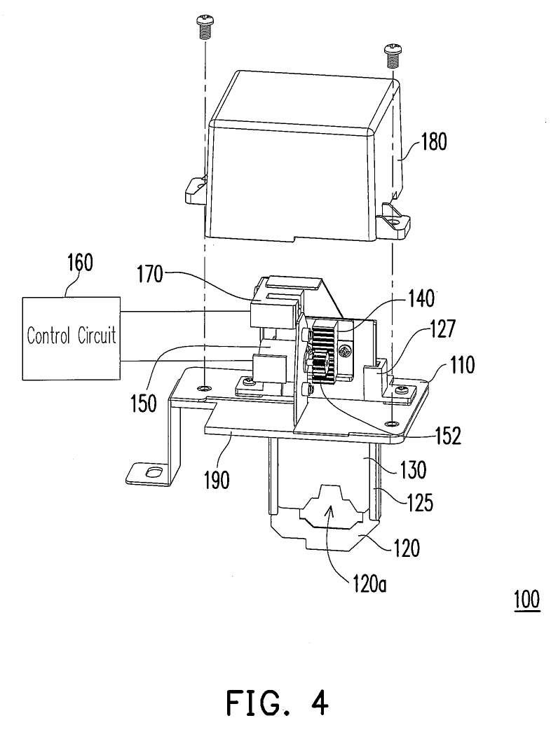

FIG. 4 is a schematic view of the automatic iris diaphragm module of FIG. 1 assembled in the casing of the projector. Referring to FIGS. 2 and 4, in order to prevent the dust from influencing the operation of the drive elements (e.g., the motor, the driving gear, the drive rack, and so on), the diaphragm module 100 further includes a dust-proof cover 180 fixed on a side of the chassis 110 and surrounding the drive rack 140, the motor 150, the driving gear 152 of the motor 150, and so on. Similarly, in order to prevent the dust from influencing the operation of the drive elements, the diaphragm module 100 further includes a dust-proof gasket 190 clamped between the chassis 110 and the casing 50. In this embodiment of the present invention, the dust-proof gasket 190 is a rubber gasket.

To sum up, in the above embodiments of the present invention, the driving gear of the motor is used to drive the drive rack fixed on the movable mask, such that the movable mask slides relative to the opening of the fixed mask, so as to adjust the size of the opening. In addition, the sliding distance of the movable mask relative to the opening can be known through the control circuit and the sensor, so as to precisely adjust the size of the opening. Moreover, the dust-proof cover and the dust-proof gasket can reduce the influence of dust on the drive elements.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An automatic iris diaphragm module, adapted to a projector having a casing, for adjusting a size of luminous flux of a light source of the projector, the automatic iris diaphragm module comprising:
a chassis, fixed on the casing;
a fixed mask, fixed on the chassis and having an opening;
a movable mask, slidably disposed on the fixed mask;
a drive rack, fixed on the movable mask; and
a motor, fixed on the chassis and having a driving gear engaging with the drive rack for driving the drive rack to make the movable mask slide relative to the fixed mask, for adjusting the size of the luminous flux of the light source through the opening.

2. The automatic iris diaphragm module as claimed in claim 1, further comprising:
a control circuit, electrically coupled to the motor, for controlling rotation of the motor.

3. The automatic iris diaphragm module as claimed in claim 2, further comprising:
a sensor, fixed on the chassis, and electrically coupled to the control circuit, for sensing a slide of the movable mask.

4. The automatic iris diaphragm module as claimed in claim 1, further comprising:
a pair of slide rails, fixed on the fixed mask, and fitting two sides of the movable mask respectively.

5. The automatic iris diaphragm module as claimed in claim 4, wherein the pair of slide rails are U-shaped and are disposed at two sides of the fixed mask respectively.

6. The automatic iris diaphragm module as claimed in claim 4, further comprising:
a pair of guide rails, fixed on the chassis and located at a side opposite to the pair of slide rails, and fitting the two sides of the movable mask respectively.

7. The automatic iris diaphragm module as claimed in claim 1, wherein the motor comprises a stepper motor.

8. The automatic iris diaphragm module as claimed in claim 1, further comprising:
a dust-proof cover, fixed on a side of the chassis, and surrounding the drive rack and the motor.

9. The automatic iris diaphragm module as claimed in claim 1, further comprising:
a dust-proof gasket, clamped between the chassis and the casing.
